(19) United States
(12) Patent Application Publication
(10) Pub. No.: US 2026/0120968 A1
(43) Pub. Date: Apr. 30, 2026

(54) Remote Shutoff Device for Circuit Protector Switch

(71) Applicant: Eaton Intelligent Power Limited, Dublin (IE)

(72) Inventors: Thomas Edward Schmitt, Collinsville, IL (US); Robert Stephen Douglass, Wildwood, MO (US)

(21) Appl. No.: 18/929,280

(22) Filed: Oct. 28, 2024

(51) Int. Cl. H01H 3/38; H01H 71/10

(52) U.S. Cl. CPC H01H 3/38; H01H 71/10

(57) ABSTRACT

In one embodiment, a remote shutoff device for a circuit protector switch including a shaft is provided. The remote shutoff device includes: a gear having a plurality of outer teeth, the gear configured to be coupled to the shaft of the circuit protector switch and to rotate with the shaft on an axis; a spring-loaded lever assembly having an arm, the arm including a first end and a second end, the second end having a plurality of inner teeth that are engageable with the plurality of outer teeth of the gear; and an actuating assembly including a latch. The remote shutoff device is operable to be armed or disengaged. When the remote shutoff device is armed, the spring-loaded lever assembly is latched by the actuating assembly in an extended position, and the circuit protector switch is operable between an ON state and an OFF state.

### TECHNICAL FIELD

This disclosure generally relates to electrical circuit protection devices, and more particularly to shutoff devices for circuit protector switches.

### BACKGROUND

Circuit protectors such as fuses are widely used as overcurrent protection devices to protect electrical components and circuits in electrical power systems from potentially damaging overcurrent conditions. For example, circuit protectors may be designed to break the circuit (e.g., by melting of fuse elements) under a certain electrical load in order to interrupt the current flowing through them. Switch components are often provided alongside the circuit protectors to allow additional control, enabling human operators to open or close the circuit as needed. However, conventional switches typically require manual operation, which comes with various limitations such as restricted accessibility, slower response time, increased safety risks, lack of convenience, and so forth. Improvements are accordingly desired.

### SUMMARY OF PARTICULAR EMBODIMENTS

This disclosure presents a shutoff device for a circuit protector switch, which is remotely controllable, allowing a user to shut off the switch from a remote location without having to physically access the switch. Specifically, the remote shutoff device may be an external accessory coupled to the switch and is capable of rotating a shaft of the switch to turn it to an OFF position. In particular, the remote shutoff device according to this disclosure is configured to receive an external electrical signal. When the signal is received, the device's various motion transmission component such as gear, arm, lever, and so on may be actuated, thereby mechanically turning the shaft to switch off the circuit protector switch, offering convenience and efficiency while ensuring safety of operation.

In particular embodiments, a remote shutoff device for a circuit protector switch including a shaft is provided. The remote shutoff device including: a gear including a plurality of outer teeth, the gear configured to be coupled to the shaft of the circuit protector switch and to rotate with the shaft on an axis; a spring-loaded lever assembly including an arm, wherein the arm includes a first end and a second end, the second end including a plurality of inner teeth that are engageable with the plurality of outer teeth of the gear; and an actuating assembly including a latch. The remote shutoff device is operable to be armed or disengaged. When the remote shutoff device is armed: the spring-loaded lever assembly is latched by the actuating assembly in an extended position, and the circuit protector switch is operable between an ON state and an OFF state.

In particular embodiments, when the remote shutoff device is armed and the remote shutoff device is thereafter disengaged, the spring-loaded lever assembly is unlatched by the actuating assembly and the spring-loaded lever assembly rotates on the axis towards a relaxed position.

In particular embodiments, if the circuit protector switch is in the ON state when the remote shutoff device is disengaged after being armed, the plurality of inner teeth of the arm engages with the plurality of outer teeth of the gear, the gear rotates with the shaft of the circuit protector switch, and the circuit protector switch is mechanically switched to the OFF state.

In particular embodiments, when the remote shutoff device is disengaged, the circuit protector switch is restricted from being switched to the ON state.

In particular embodiments, the plurality of outer teeth of the gear includes two outer teeth that are opposite to each other.

In particular embodiments, the plurality of inner teeth of the second end of the arm includes two inner teeth that are opposite to each other.

In particular embodiments, the second end of the arm further includes an opening for receiving the gear.

In particular embodiments, the gear further includes a through hole for receiving an end of the shaft of the circuit protector switch.

In particular embodiments, the first end of the arm includes a notch for engaging with the latch when the remote shutoff device is armed.

In particular embodiments, the actuating assembly further includes a solenoid configured to actuate the latch based on an external electrical signal.

In particular embodiments, the remote shutoff device further includes a reset mechanism coupled to the spring-loaded lever assembly, the reset mechanism configured to reset the remote shutoff device from disengaged to armed.

In particular embodiments, the reset mechanism includes a handle that is manually operable and is coupled to the arm of the spring-loaded lever assembly.

In particular embodiments, the reset mechanism further includes a reset spring coupled to the handle and configured for biasing the handle.

In particular embodiments, the reset mechanism includes a reset button that is manually operable and is coupled to the arm of the spring-loaded lever assembly.

In particular embodiments, the reset mechanism further includes a reset lever coupled between the reset button and the arm of the spring-loaded lever assembly.

In particular embodiments, a remote shutoff device for a circuit protector switch including a shaft is provided. The remote shutoff device includes: a gear including a plurality of outer teeth, the gear configured to be coupled to the shaft of the circuit protector switch and to rotate with the shaft on an axis; a spring-loaded lever assembly including an arm, wherein the arm includes a first end and a second end, the second end including a plurality of inner teeth that are engageable with the plurality of outer teeth of the gear; an actuating assembly including a latch; and a reset mechanism coupled to the spring-loaded lever assembly. The remote shutoff device is operable to be armed or disengaged. The reset mechanism is configured to reset the remote shutoff device from disengaged to armed. When the remote shutoff device is armed: the spring-loaded lever assembly is latched by the actuating assembly in an extended position, and the circuit protector switch is operable between an ON state and an OFF state.

In particular embodiments, when the remote shutoff device is armed and the remote shutoff device is thereafter disengaged, the spring-loaded lever assembly is unlatched by the actuating assembly and the spring-loaded lever assembly rotates on the axis towards a relaxed position.

In particular embodiments, if the circuit protector switch is in the ON state when the remote shutoff device is disengaged after being armed, the plurality of inner teeth of the arm engages with the plurality of outer teeth of the gear, the gear rotates with the shaft of the circuit protector switch, and the circuit protector switch is mechanically switched to the OFF state.

In particular embodiments, when the remote shutoff device is disengaged, the circuit protector switch is restricted from being switched to the ON state.

In particular embodiments, a circuit protector assembly includes one or more circuit protectors having one or more circuit protector switches, the one or more circuit protector switches rotatably connected via a shaft; and a remote shutoff device. The remote shutoff device includes: a gear including a plurality of outer teeth, the gear configured to be coupled to the shaft and to rotate with the shaft on an axis; a spring-loaded lever assembly including an arm, wherein the arm includes a first end and a second end, the second end including a plurality of inner teeth that are engageable with the plurality of outer teeth of the gear; and an actuating assembly including a latch. The remote shutoff device is operable to be armed or disengaged. When the remote shutoff device is armed: the spring-loaded lever assembly is latched by the actuating assembly in an extended position, and the one or more circuit protector switches are operable between an ON state and an OFF state.

### BRIEF DESCRIPTION OF THE DRAWINGS

Embodiments in accordance with this disclosure will now be described by reference to the accompanying drawings.

FIG. 1 illustrates an embodiment of a remote shutoff device coupled to a circuit protector switch.

FIG. 2 illustrates a stand-alone view of the remote shutoff device, with its cover removed to show its interior components.

FIG. 3A illustrates the circuit protector switch in the OFF state with the remote shutoff device armed.

FIG. 3B illustrates the circuit protector switch in the ON state, with the remote shutoff device armed.

FIG. 4A illustrates the remote shutoff device in the armed position when the circuit protector switch is in the OFF state.

FIG. 4B illustrates the remote shutoff device in the armed position when the circuit protector switch is in the ON state.

FIG. 5A illustrates a perspective view of FIG. 4A, in which the remote shutoff device is in the armed position when the circuit protector switch is in the OFF state.

FIG. 5B illustrates a perspective view of FIG. 4B, in which the remote shutoff device is in the armed position when the circuit protector switch is in the ON state.

FIG. 6A illustrates the remote shutoff device in the disengaged position, with the circuit protector switch in motion to the OFF state.

FIG. 6B illustrates the remote shutoff device in the disengaged position, with the circuit protector switch completely turned to the OFF state.

FIG. 7A illustrates a perspective view of FIG. 6A, in which the remote shutoff device is in the disengaged position, with the circuit protector switch in motion to the OFF state.

FIG. 7B illustrates a perspective view of FIG. 6B, in which the remote shutoff device is in the disengaged position, with the circuit protector switch completely turned to the OFF state.

FIG. 8A illustrates the remote shutoff device being re-armed from disengaged toward the armed position when the circuit protector switch is in the OFF state.

FIG. 8B illustrates the remote shutoff device fully reset into the armed position when the circuit protector switch is in the OFF state. This corresponds to FIG. 4A.

FIG. 9A illustrates a perspective view of FIG. 8A, in which the remote shutoff device is being re-armed from disengaged toward the armed position when the circuit protector switch is in the OFF state.

FIG. 9B illustrates a perspective view of FIG. 8B, in which the remote shutoff device is fully reset into the armed position when the circuit protector switch is in the OFF state. This corresponds to FIG. 5A.

FIG. 10 illustrates another embodiment of a remote shutoff device, with its cover removed to show its interior components.

### DESCRIPTION OF EXAMPLE EMBODIMENTS

Circuit protectors including fusible devices are typically used to provide overcurrent protection in an electrical circuitry. For example, during operation when the current in the circuitry exceeds a particular limit, a circuit protector is configured to break the circuitry, for example, via melting of the fuse, thereby stopping the flow of electricity. This mitigates damage to the electrical system by preventing high current from reaching sensitive circuit components. To add additional control without solely relying on the fuse blowing due to overcurrent, for example, circuit protector switches may be used, allowing a user to manually disconnect or reconnect the circuit for maintenance, testing, safety, or other various purposes. However, such manually operated switches may have inherent drawbacks such as the need for physical presence of a human operator to operate, which may be inconvenient and slows down response times, particularly in emergencies. They are also prone to human error, as the operator may erroneously operate the device, or may pose safety risks due to the need to enter potentially hazardous area to manually disconnect the power.

As a solution, the embodiments disclosed herein present a remote shutoff device that is remotely controllable in order to switch off the switch, thereby disconnecting power quickly and safely without requiring an operator to physically access the switch locations. Specifically, the device may be configured to receive an external electrical signal, which may trigger its various motion components to mechanically turn off the circuit protector switch. Due to the mechanical nature of motion transmission, wear and tear effects experienced by the switch may be prevented or at least reduced. In particular, the remote shutoff device may be configured to move to different operation positions based on command, such as a disengaged position where the switch is restricted from being switched to an ON state, or an armed position in which the switch is operable between an ON state and an OFF state, thereby offering flexibility for human operation while ensuring safety. Moreover, since the remote shutoff device is designed as an external accessory to the circuit protector switch, this eliminates the need for significant retrofitting, allowing the device to be coupled to existing equipment simply and easily.

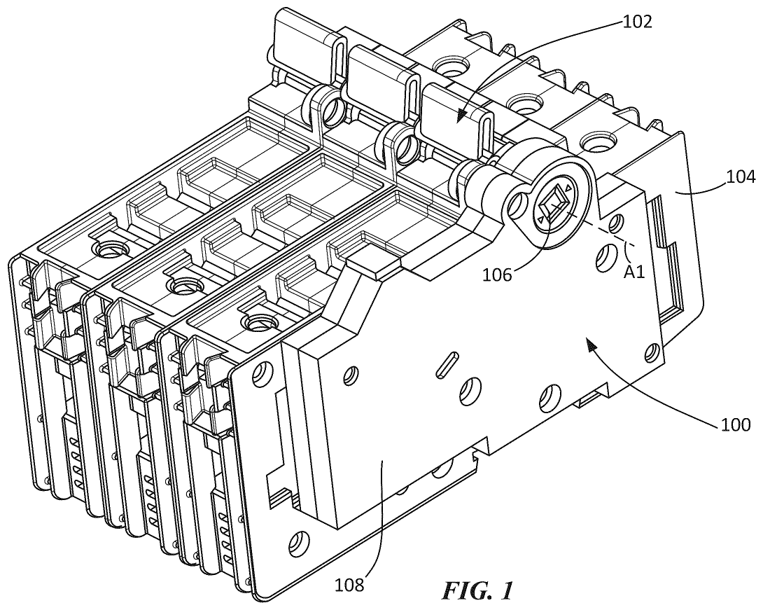

FIG. 1 illustrates an embodiment of a remote shutoff device 100 coupled to a circuit protector switch 102. In particular embodiments, the circuit protect switch 102 may be part of or otherwise coupled to a circuit protector 104, providing control over the circuit protector 104 so as to switch on or off the circuit protector 104 as needed. As an example and not by way of limitation, specifically, a user may switch, via the switch 102, the circuit protector 104 to an ON state, which closes the circuit, allowing current to flow through the circuit protector 104 for normal operation, or to an OFF state to disconnect electrical load and isolate the circuit protector 104. In particular embodiments, as shown, the circuit protector switch 102 may be an individual switch for each circuit protector 104. Alternatively or additionally, in particular embodiments, although not shown, the circuit protector switch 102 may be a single master switch configured to control switching of multiple circuit protectors.

In particular embodiments, the circuit protector switch 102 may include a shaft 106, which may rotate on an axis A1 as the circuit protector switch 102 is switched. The remote shutoff device 100 may be coupled to the shaft 106 to control shaft rotation and consequently to control switching of the circuit protector switch 102. In particular embodiments, the remote shutoff device 100 may be configured as a side-mounted accessory installed on a lateral side (e.g., right-or left-hand side) of the circuit protector 104 and operatively coupled to the switch 102 via the shaft 106. This may be beneficial in applications with tight space constraints, especially if the line-to-load or back-to-front side dimensions are limited. As an example and not by way of limitation, as shown, the remote shutoff device 100 may include a housing 108 for housing its various components and may be attached to the side of the circuit protector 104. For example, fasteners such as screws, bolts, or the like may be used to attach the housing 108 to the circuit protector 104. Alternatively or additionally, in particular embodiments, the remote shutoff device 100 may be installed elsewhere such as for example at a central distribution unit (e.g., a fuse box) that accommodates multiple circuit protectors 104. In this case, for example, the remote shutoff device 100 may be coupled to a master switch of the unit rather than being directly attached to the circuit protector 104 itself.

In particular embodiments, the circuit protector 104 may be a fusible circuit protector having a fuse element. As an example and not by way of limitation, as shown, three circuit protectors 104 may be coupled together, forming a three-pole fuse assembly for accommodating one working fuse for each of the three phases to provide individual circuit protection for each phase. Alternatively or additionally, a single-pole fuse assembly or a multi-pole fuse assembly may be provided, which may accommodate any suitable number of fuse(s) and is compatible with various embodiments of the remote shutoff device 100. In particular embodiments, other circuit protection devices such as active circuit breakers are also envisioned for use with the remote shutoff device 100. Although this disclosure describes a remote shutoff device for use with a particular circuit protector, this disclose contemplates remote shutoff devices for use with any suitable circuit protectors.

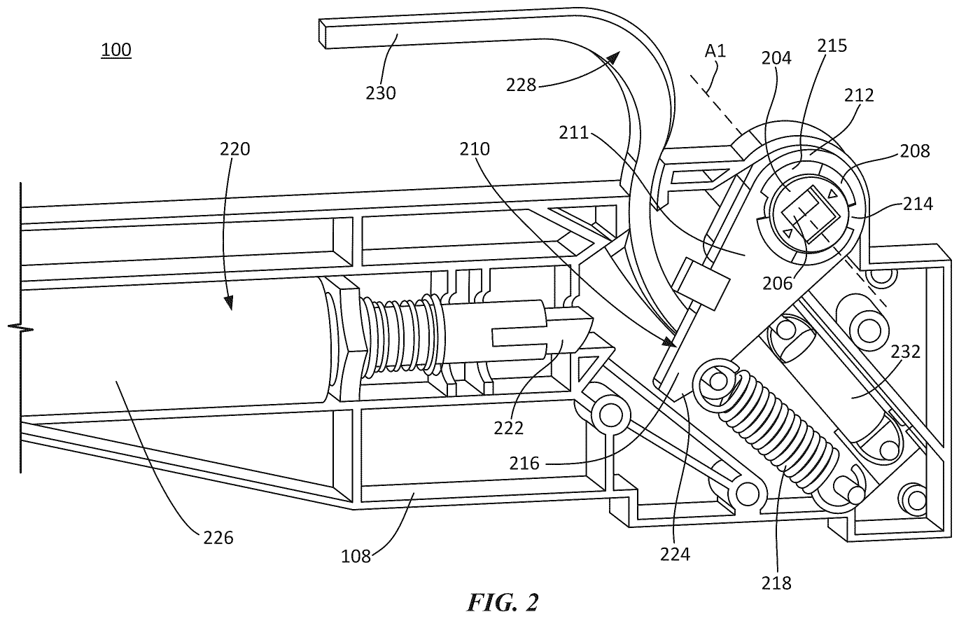

FIG. 2 illustrates the remote shutoff device 100 in isolation, with its cover removed to better observe its interior. In particular embodiments, as discussed, the remote shutoff device 100 may be coupled to the shaft 106 of the circuit protector switch 102 (not visible in FIG. 2). To this end, a gear 204 may be provided, which may be fitted onto an end of the shaft 106 and configured to rotate with the shaft 106, for example, on the axis A1 as shown. As an example and not by way of limitation, the gear 204 may include an opening 206 near its center for receiving an end of the shaft 106. The opening 206 may have a shape that corresponds to the outer contour of the shaft 106 such that rotation of the shaft 106 causes the gear 204 to rotate accordingly, or vice versa. While depicted as a through hole that is generally square in shape, the opening 206 may be configured differently such as in the form of a slot, a bore, a recess, and so forth, and may be in any suitable shapes such as circular or non-circular, rectangular, polygonal, irregular in shape, and so on, provided that it allows proper rotation transmission with the shaft 106.

In particular embodiments, the gear 204 may be coupled to a lever assembly 210 such as at an end of an arm 211 of the lever assembly 210. As an example and not by way of limitation, the gear 204 may include multiple outer teeth 208 along the circumferential direction. In particular embodiments, a first end 212 of the arm 211 may include multiple teeth 214 that are engageable with the outer teeth 208 of the gear 204. Specifically, as an example and not by way of limitation, the first end 212 of the arm 211 may include an opening 215 for receiving the gear 204. The teeth 214 may be arranged on the inner side of the opening 215 to engage with the outer teeth 208 of the gear 204.

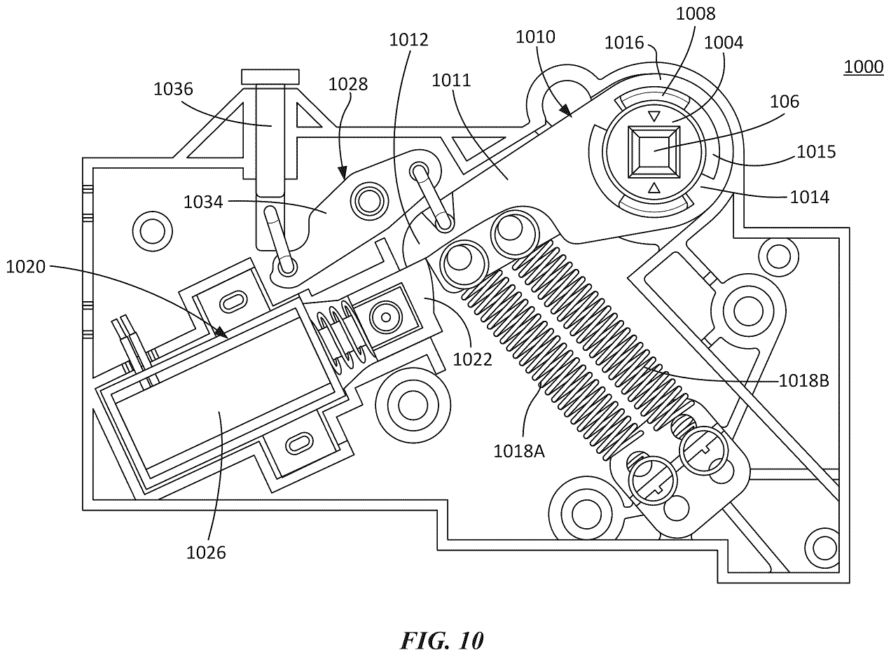

In particular embodiments, the lever assembly 210 may be spring-loaded or otherwise biased. As an example and not by way of limitation, a spring 218 may be connected to the second end 216 of the arm 211 opposite the first end 212, pulling the second end 216 downward. Alternatively or additionally, other biasing elements such as elastic bands, tension rods, compression rods, etc. may be used for biasing the arm 211. Although FIG. 2 depicts the lever assembly 210 having only one spring, the lever assembly 210 may be configured with any suitable number of springs (e.g., two springs as shown in FIG. 10) or with any suitable biasing elements for providing the desired force balance.

In particular embodiments, the remote shutoff device 100 may also include an actuating assembly 220, which may be arranged in proximity to the second end 216 of the arm 211. The actuating assembly 220 may include a latch 222 that is configured to either extend or retract. In the extended position, the latch 222 may engage with the second end 216 of the arm 211 to latch the arm 211 in place, resisting the biasing force of the spring 218. The remote shutoff device 100 is therefore armed (or engaged as used interchangeably herein). As an example and not by way of limitation, the second end 216 of the arm 211 may include a notch 224 for engaging with the latch 222, although other configurations are also envisioned such as a slot, an opening, a recess, etc. for receiving the latch 222. On the other hand, when retracted, the latch 222 may unlatch the arm 211. The arm 211 is thus allowed to rotate downward about the axis A1 into a relaxed position due to biasing of the spring 218. This way, the remote shutoff device 100 is disengaged (or triggered as used interchangeably herein). This is the state shown in FIG. 2.

In particular embodiments, although not shown, positions of the actuating assembly 220 and the spring 218 may be swapped such that the spring 218 is coupled to the arm 211 from the left of the figure while the actuating assembly 220, or specifically the latch 222, is coupled to the arm 211 from the right. As an example and not by way of limitation, in this configuration, the spring 218 may be a compression spring, exerting a pushing force on the arm 211 against the latch 222, rather than pulling the arm 211 as described above.

In particular embodiments, the actuating assembly 220 may be configured to receive an external electrical signal, thereby allowing remote control thereof. As an example and not by way of limitation, the actuating assembly 220 may include a solenoid 226 coupled to the latch 222 for actuating the latch 222 between the extended and retracted positions in response to the signal. This way, a user may remotely control operation of the device 100 so as to turn off the switch 102 if desired, without having to physically access the switch 102. Alternatively or additionally, other remotely controllable actuation components may be used such as for example motors, actuators, etc.

In particular embodiments, a reset mechanism 228 may be provided in order to allow the lever assembly 210 to be reset. The reset mechanism may include a handle 230, a lower end of which may be coupled to the lever assembly 210 such as near the second end 216 of the arm 211, while the upper end may extend out of the housing 108 and may be accessible by an operator. This way, when the arm 211 is disengaged from the latch 222, the operator may pull up the handle 230, thereby lifting the arm 211 until it is back into engagement with the latch 222. The remote shutoff device 100 is thus re-armed and ready for further operation. In particular embodiments, a reset spring 232 may be connected to the handle 230, such as at its lower end as depicted, and configured to bias down the handle 230. Alternatively or additionally, other biasing elements such as elastic bands, tension rods, compression rods, etc. may be used for biasing the handle 230.

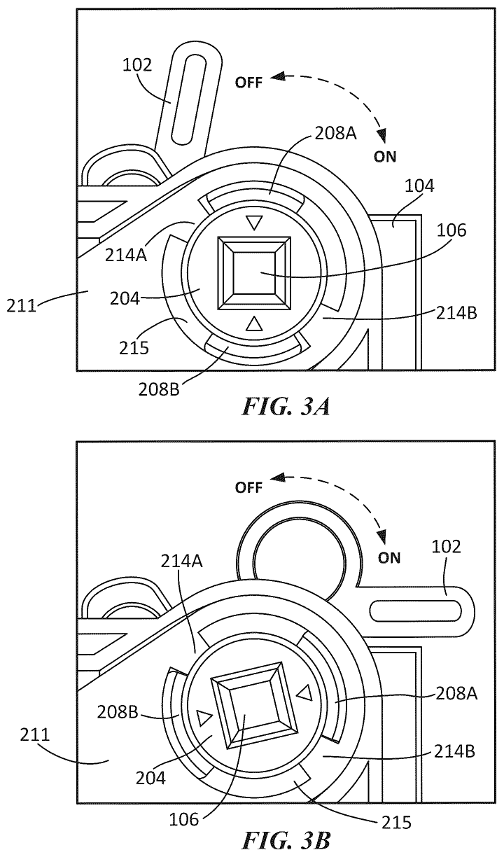

FIGS. 3A-3B illustrate close-up views of the remote shutoff device 100 connected to the shaft 106 of the switch 102, specifically showing the configuration when the switch 102 is in the OFF state (FIG. 3A) and ON state (FIG. 3B), respectively. Depending on the particular specification of circuit protector switch 102, the shaft 106 may rotate by a particular degree as the switch 102 is switched from off to on, and vice versa. Advantageously, the remote shutoff device 100 according to particular embodiments of the disclosure may be configured to compensate for different angular travels of different switches while allowing the switches to be turned on and off without interaction or hinderance. Specifically, for example, this may occur when the device 100 is in the armed position, i.e., when the arm 211 is held by the latch 222.

In particular embodiments, the gear 204 and the arm 211 may be designed to allow relative angular movement between them such that the gear 204 may be able to rotate a certain degree, for example, inside the opening 215 of the arm 211, without actuating the arm 211. As an example and not by way of limitation, two outer teeth 208A and 208B of the gear 204 may be arranged at about 180 degrees apart from one another. Similarly, two inner teeth 214A and 214B inside the opening 215 of the arm 211 may be disposed opposite each other approximately 180 degrees apart. As such, due to the spacings between the teeth, this provides a limited degree of rotation where the gear 204 may move freely without transmitting torque or force to the arm 211. As an example and not by way of limitation, as illustrated, in the armed position of the remote shutoff device 100, the angular distance from the teeth 208A to teeth 214B may substantially correspond to the angular range of motion needed for switching the switch 102. This way, the circuit protector switch 102 may be operable freely between the ON state and the OFF state without being restrained by the remote shutoff device 100 when armed. It should be noted that the configurations described above are exemplary only and are not intended to limit the scope of the disclosure. In this regard, for example, the gear and the arm may include any suitable numbers of teeth such as three, four, five, or more, which teeth may be meshed or separated apart in any suitable manner, provided that they allow for certain amount of relative rotation between the gear and the arm.

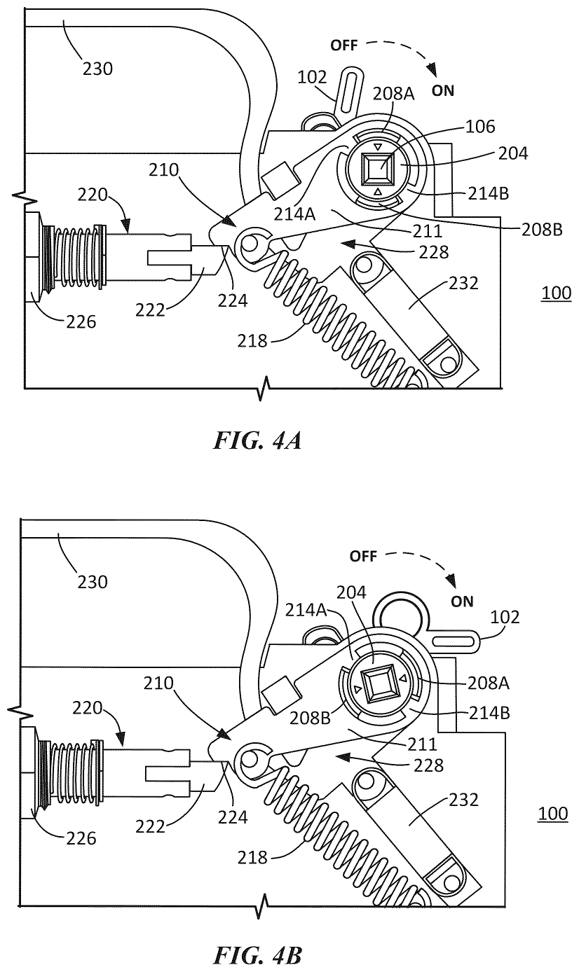

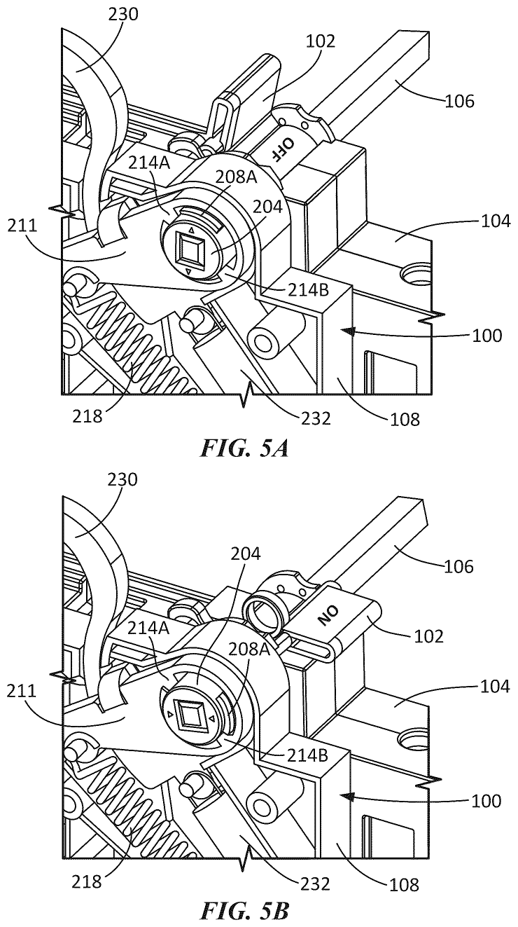

FIGS. 4A-5B illustrate the remote shutoff device 100 in the armed position when the circuit protector switch 102 is in the OFF state (FIGS. 4A and 5A) and ON state (FIGS. 4B and 5B), respectively. In particular embodiments, as already explained, in the armed position, the latch 222 may be extended to engage with the arm 211, holding the arm 211 in position while resisting the spring 218. Moreover, the gear 204 may be allowed to rotate a particular degree, based on turning of the shaft 106 of the switch 102, without being restricted by the lever assembly 210. Additionally, the handle 230 may remain at its default, un-lifted position under the downward biasing force of the reset spring 232.

In particular embodiments, operation may start with the initial phase shown in FIGS. 4A and 5A when the remote shutoff device 100 is armed and the circuit protector switch 102 off. As the switch 102 is turned on, for example, by the operator pressing on the switch 102 in the direction indicated, the gear 204 may rotate such that its outer tooth 208A travels from the position of one inner tooth 214A to the position of the other inner tooth 214B. This is shown in FIGS. 4B and 5B. In other words, when the switch 102 is turned on, the outer teeth 208A and 208B of the gear 204 may contact the inner teeth 214A and 214B of the arm 211 along a clockwise direction. The remote shutoff device 100 is now in standby and ready to shut off the switch 102 when triggered.

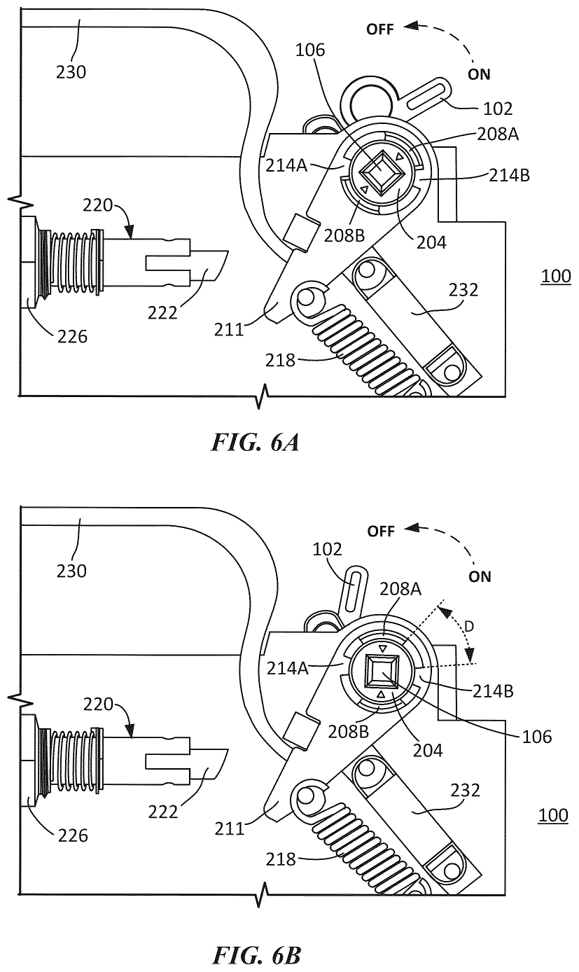

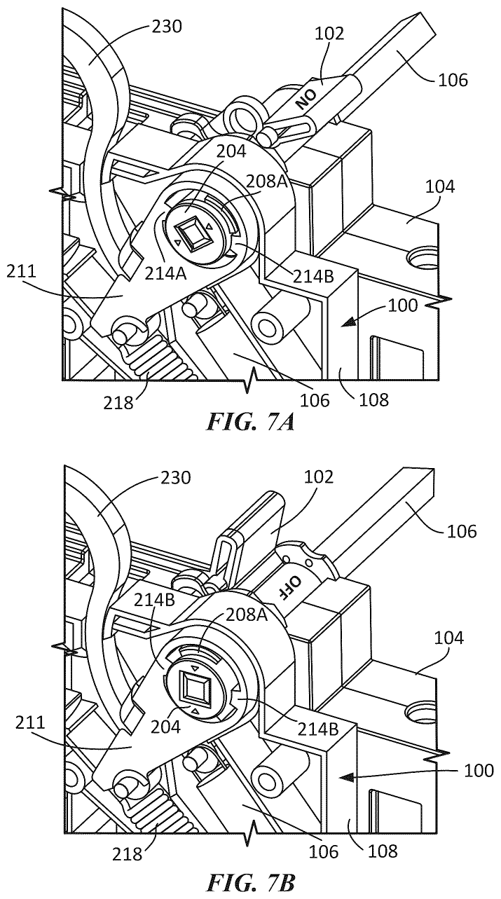

FIGS. 6A-7B illustrate the remote shutoff device 100 in the disengaged position, with the circuit protector switch 102 in motion to the OFF state (FIGS. 6A and 7A) until completely turned to the OFF state (FIGS. 6B and 7B), respectively. In particular embodiments, an electrical signal may be sent to the actuating assembly 220, thereby energizing the solenoid 226. The solenoid 226 may then withdraw the latch 222 such that the arm 211 is disengaged and released from the latch 222. Once released, the arm 211 may rotate counterclockwise under the downward force of the spring 218. Since the outer teeth 208A and 208B of the gear 204 is in contact with the inner teeth 214A and 214B of the arm 211 along the clockwise direction, movement of the arm 211 in the opposite direction may accordingly actuate the gear 204. Based on such gear rotation, the shaft 106 is therefore turned, switching the circuit protector switch 102 towards the OFF state.

In particular embodiments, when the arm 211 reaches its stop and is completely relaxed, the switch 102 may continue to turn (for example, due to a switch spring preloading the switch) until it fully reaches the OFF state. This is depicted in FIGS. 6B and 7B. In particular embodiments, in this configuration, i.e., with the remote shutoff device 100 triggered and the switch 102 off, the outer teeth 208A of the gear 204 and the inner teeth 214B of the arm 211 may be separated by an angular distance D. As an example and not by way of limitation, the angular distance D may be smaller than the amount of travel required for switching on the switch 102 such that any attempt to turn the switch 102 back to the ON state is blocked by the arm 211. This way, the circuit protector switch 102 is prevented from being turned from OFF to ON state unless the arm 211 is reset back up into the armed position. This ensures the switch 102 cannot be inadvertently activated until the remote shutoff device 100 is re-armed, thus reducing the risk of accidentally turning on the switch 102. Configured as such, the remote shutoff device 100 requires the operator to confirm that the system is in a secure and controlled state before power can be restored.

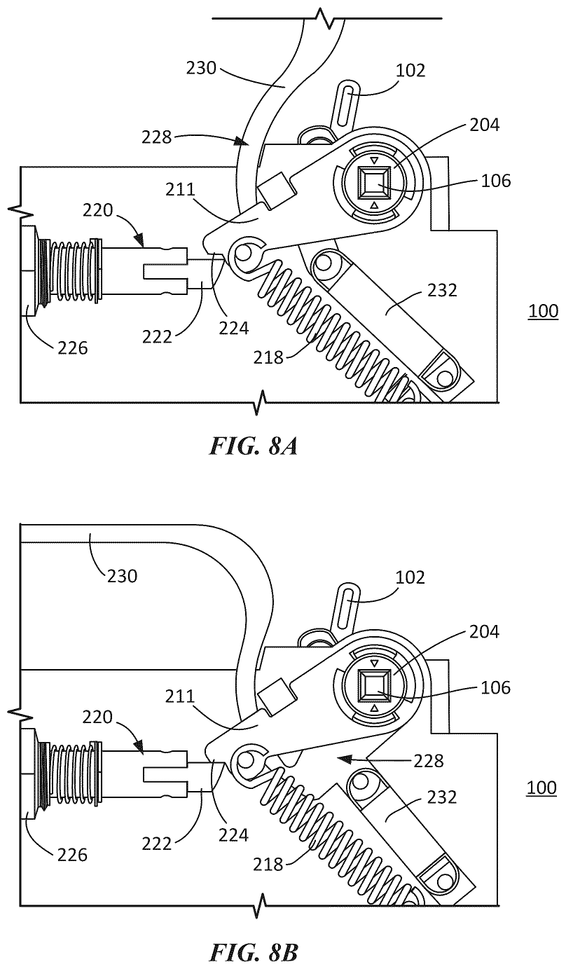

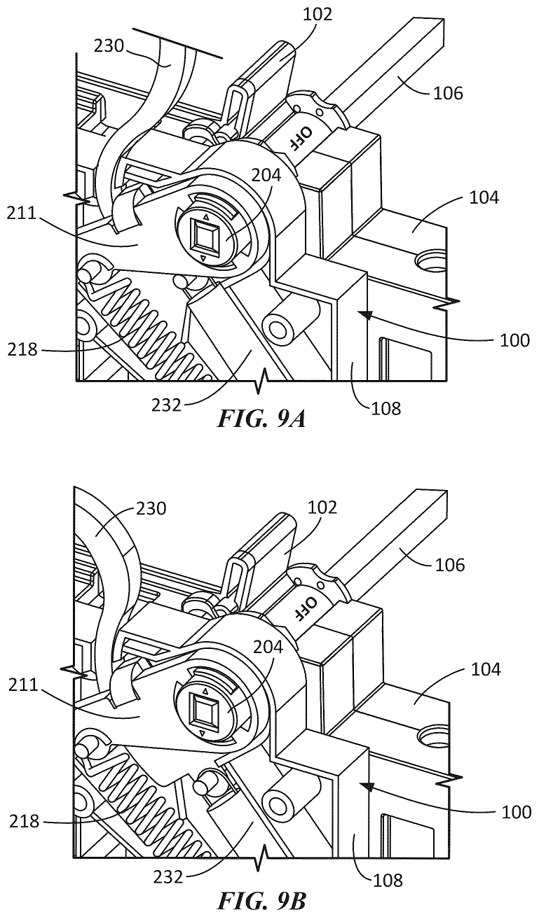

FIGS. 8A-9B illustrate the remote shutoff device 100 being re-armed (FIGS. 8A and 9A) to the fully armed position (FIGS. 8B and 9B) when the circuit protector switch 102 is in the OFF state. In particular embodiments, the re-arm process may be manually implemented, for example, by the operator pulling on the handle 230 of the reset mechanism 228. As the handle 230 is lifted, overcoming the force of the springs 218 and 232, the arm 211 may be correspondingly raised. The latch 222 may yield, giving way for the arm 211 to move further upward to a position above the latch 222. As an example and not by way of limitation, the end of the latch 222 may be slanted in order to facilitate upward motion of the arm 211. Once the handle 230 is released, the arm 211 may drop due to the spring load and engage with the latch 222 via the notch 224. During this process, the gear 204 and therefore the circuit protector switch 102 remain still in the OFF state.

In particular embodiments, alternatively or additionally, the reset mechanism 228 may be remotely operated. As an example and not by way of limitation, while not depicted, an actuator or a lock may be coupled to the handle 230 or otherwise to the arm 211 and configured to actuate or lock the handle 230 or the arm 211 based on an external control signal. This way, resetting of the remote shutoff device 100 to the armed position may be done without the need for manual intervention, further adding convenience and efficiency. Moreover, without the reset command, the circuit protector switch 102 may be retained at the OFF state and is prevented from unauthorized switching to the ON state by individuals even if they can physically assess the switch 102, thus protecting the switch 102 from tempering or accidental activation, further reducing the risk of electrical hazards or equipment damage.

FIG. 10 illustrates another embodiment of a remote shutoff device 1000. The remote shutoff device 1000 may incorporate the features disclosed herein and is compatible with the embodiments of the remote shutoff device 100 described above with reference to FIGS. 1-9B. In particular embodiments, the remote shutoff device 100 may include a gear 1004 having multiple outer teeth 1008 and configured to be coupled to the shaft 106 and to rotate with the shaft 106. A lever assembly 1010 may be coupled to the gear 1004. For example, the lever assembly 1010 may include an arm 1011 having a first end 1012 and a second end 1016. The second end 1016 may include an opening 1015 that receives the gear 1004. Specifically, the opening 1015 may have multiple inner teeth 1014 that are engageable with the outer teeth 1008 of the gear 1004. The remote shutoff device 1000 may also include an actuating assembly 1020 having a latch 1022, which may be configured to extend or retract based on actuation by a solenoid 1026. In the extended position, the latch 1022 may engage with the arm 1011 at its first end 1012. Configured as such, the circuit protector switch 102 may be operable between the ON state, closing the circuit, and the OFF state, disconnecting the circuit.

In particular embodiments, two springs 1018A and 1018B may be provided, which may be attached to the arm 1011 near its first end 1012, biasing it against the latch force of the actuating assembly 1020. Although depicted as such, the lever assembly 1010 may be configured with any suitable number of springs or with any suitable biasing elements such as elastic bands, tension rods, compression rods, etc. for providing the desired force balance.

In particular embodiments, a reset mechanism 1028 may be provided in order to allow the lever assembly 1010 to be reset, for example, to the armed position. As illustrated, the reset mechanism 1028 may include a reset lever 1034. The reset lever 1034 may be rotatably supported inside the device and has one end coupled to the first end 1012 of the arm 1011 and the other end to a reset button 1036. As an example and not by way of limitation, when the arm 1011 is disengaged and rotates down counterclockwise, the reset lever 1034 may correspondingly rotate, thereby pushing up the reset button 1036. When re-arming of the remote shutoff device 1000 is needed, an operator may press down on the reset button 1036, which may in turn actuate the reset lever 1034 such that it rotates and lifts up the arm 1011, resisting the spring force, until the arm 1011 re-engages with the latch 1022 to the position as shown in FIG. 10. Of course, additionally or alternatively, similar to the embodiments described above with reference to the reset mechanism 228, the reset mechanism 1028 may be remotely controllable without requiring manual operation.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A remote shutoff device for a circuit protector switch comprising a shaft, the remote shutoff device comprising:
a gear comprising a plurality of outer teeth, the gear configured to be coupled to the shaft of the circuit protector switch and to rotate with the shaft on an axis;
a spring-loaded lever assembly comprising an arm, wherein the arm comprises a first end and a second end, the second end comprising a plurality of inner teeth that are engageable with the plurality of outer teeth of the gear; and
an actuating assembly comprising a latch;
wherein the remote shutoff device is operable to be armed or disengaged, wherein when the remote shutoff device is armed:
the spring-loaded lever assembly is latched by the actuating assembly in an extended position, and
the circuit protector switch is operable between an ON state and an OFF state.

2. The remote shutoff device of claim 1, wherein, when the remote shutoff device is armed and the remote shutoff device is thereafter disengaged, the spring-loaded lever assembly is unlatched by the actuating assembly and the spring-loaded lever assembly rotates on the axis towards a relaxed position.

3. The remote shutoff device of claim 2, wherein, if the circuit protector switch is in the ON state when the remote shutoff device is disengaged after being armed, the plurality of inner teeth of the arm engages with the plurality of outer teeth of the gear, the gear rotates with the shaft of the circuit protector switch, and the circuit protector switch is mechanically switched to the OFF state.

4. The remote shutoff device of claim 1, wherein when the remote shutoff device is disengaged, the circuit protector switch is restricted from being switched to the ON state.

5. The remote shutoff device of claim 1, wherein the plurality of outer teeth of the gear comprises two outer teeth that are opposite to each other.

6. The remote shutoff device of claim 1, wherein the plurality of inner teeth of the second end of the arm comprises two inner teeth that are opposite to each other.

7. The remote shutoff device of claim 1, wherein the second end of the arm further comprises an opening for receiving the gear.

8. The remote shutoff device of claim 1, wherein the gear further comprises a through hole for receiving an end of the shaft of the circuit protector switch.

9. The remote shutoff device of claim 1, wherein the first end of the arm comprises a notch for engaging with the latch when the remote shutoff device is armed.

10. The remote shutoff device of claim 1, wherein the actuating assembly further comprises a solenoid configured to actuate the latch based on an external electrical signal.

11. The remote shutoff device of claim 1, further comprising:
a reset mechanism coupled to the spring-loaded lever assembly, the reset mechanism configured to reset the remote shutoff device from disengaged to armed.

12. The remote shutoff device of claim 11, wherein the reset mechanism comprises a handle that is manually operable and is coupled to the arm of the spring-loaded lever assembly.

13. The remote shutoff device of claim 12, wherein the reset mechanism further comprises a reset spring coupled to the handle and configured for biasing the handle.

14. The remote shutoff device of claim 11, wherein the reset mechanism comprises a reset button that is manually operable and is coupled to the arm of the spring-loaded lever assembly.

15. The remote shutoff device of claim 14, wherein the reset mechanism further comprises a reset lever coupled between the reset button and the arm of the spring-loaded lever assembly.

16. A remote shutoff device for a circuit protector switch comprising a shaft, the remote shutoff device comprising:
a gear comprising a plurality of outer teeth, the gear configured to be coupled to the shaft of the circuit protector switch and to rotate with the shaft on an axis;
a spring-loaded lever assembly comprising an arm, wherein the arm comprises a first end and a second end, the second end comprising a plurality of inner teeth that are engageable with the plurality of outer teeth of the gear;
an actuating assembly comprising a latch; and
a reset mechanism coupled to the spring-loaded lever assembly;
wherein the remote shutoff device is operable to be armed or disengaged, wherein the reset mechanism is configured to reset the remote shutoff device from disengaged to armed, wherein when the remote shutoff device is armed:
the spring-loaded lever assembly is latched by the actuating assembly in an extended position, and
the circuit protector switch is operable between an ON state and an OFF state.

17. The remote shutoff device of claim 16, wherein, when the remote shutoff device is armed and the remote shutoff device is thereafter disengaged, the spring-loaded lever assembly is unlatched by the actuating assembly and the spring-loaded lever assembly rotates on the axis towards a relaxed position.

18. The remote shutoff device of claim 17, wherein, if the circuit protector switch is in the ON state when the remote shutoff device is disengaged after being armed, the plurality of inner teeth of the arm engages with the plurality of outer teeth of the gear, the gear rotates with the shaft of the circuit protector switch, and the circuit protector switch is mechanically switched to the OFF state.

19. The remote shutoff device of claim 16, wherein when the remote shutoff device is disengaged, the circuit protector switch is restricted from being switched to the ON state.

20. A circuit protector assembly comprising:
One or more circuit protectors having one or more circuit protector switches, the one or more circuit protector switches rotatably connected via a shaft; and
a remote shutoff device comprising:
a gear comprising a plurality of outer teeth, the gear configured to be coupled to the shaft and to rotate with the shaft on an axis;
a spring-loaded lever assembly comprising an arm, wherein the arm comprises a first end and a second end, the second end comprising a plurality of inner teeth that are engageable with the plurality of outer teeth of the gear; and
an actuating assembly comprising a latch;
wherein the remote shutoff device is operable to be armed or disengaged, wherein when the remote shutoff device is armed:
the spring-loaded lever assembly is latched by the actuating assembly in an extended position, and
the one or more circuit protector switches are operable between an ON state and an OFF state.
